(19) United States
(12) Patent Application Publication
(10) Pub. No.: US 2026/0281130 A1
(43) Pub. Date: Sep. 17, 2026

(54) Virtual IT and Cybersecurity Administrator Utilizing AI-Powered Playbooks

(71) Applicant: Espresso Labs Inc, Los Altos, CA (US)

(72) Inventors: Adi Ruppin, Los Altos, CA (US); Ido Green, Los Altos, CA (US)

(21) Appl. No.: 19/567,517

(22) Filed: Mar. 16, 2026

Related U.S. Application Data
(60) Provisional application No. 63/772,853, filed on Mar. 17, 2025.

(51) Int. Cl. H04L 9/40

(52) U.S. Cl. CPC H04L 63/1416; H04L 63/1441; H04L 63/20

(57) ABSTRACT

A unified, AI-powered multi-tenant virtual IT and cybersecurity administrator for managing and securing multiple IT domains through intelligent playbook-based workflows. The system utilizes machine learning to recommend and generate playbooks based on organizational needs, automates response actions through script execution and ticket creation, and provides continuous optimization through event collection and analysis. The system supports multiple organizations while maintaining data isolation and enabling shared learning benefits.

### TECHNICAL FIELD

The present invention relates to the field of information technology (IT) management and cybersecurity, specifically to automated systems for managing, monitoring, and securing multiple technological domains through intelligent playbook-based workflows.

### BACKGROUND

Modern organizations face increasing complexity in managing and securing their IT infrastructure across multiple domains, such as users, devices, applications, and data. Traditional solutions, such as Remote Monitoring and Management (RMM) systems, Professional Services Automation (PSA), Endpoint Detection and Response (EDR), Security Orchestration, Automation, and Response (SOAR), and others handle each domain or subdomain separately and require numerous point solutions and significant human resources to support these tools. This leads to inefficiencies and security gaps.

In addition, traditional solutions lack intelligent automation and therefore require manual and labor-intensive creation, implementation, monitoring, and maintenance of IT and cybersecurity workflows. There is a need for a unified system that can automatically generate, adapt and continuously execute playbooks based on organizational and contextual needs while providing comprehensive coverage across all IT domains.

Lastly, modern regulatory frameworks and security standards-such as SOC 2, ISO 27001, and CMMC—introduce extensive compliance requirements that organizations must operationalize within their day-to-day IT and security activities. In practice, these requirements are often documented as lists of controls within spreadsheets or static documentation, creating a disconnect between compliance frameworks and the actual operational actions required to satisfy them. Organizations therefore face a significant challenge in translating these control statements into concrete, repeatable tasks that can be executed, monitored, and validated within their technology environments. There is a need for systems that can map such control definitions into actionable operational outcomes, enabling continuous monitoring of compliance posture, automated triage of control deficiencies, and structured support for gathering and maintaining the evidence necessary for audits and assessments.

### SUMMARY

The present invention provides a unified, artificial intelligence (AI) powered virtual IT and cybersecurity administrator system that intelligently manages and secures multiple IT domains through automated playbook-based workflows, while also addressing organizational compliance requirements by mapping regulatory and security controls to operational actions, enforcing such actions, and continuously monitoring their execution.

As noted above, regulatory compliance requirements create ongoing challenges. A further technical challenge arises from the structural mismatch between how regulatory compliance requirements are expressed and how IT and cybersecurity systems are configured and monitored. Regulatory frameworks such as SOC 2, ISO 27001, HIPAA, CMMC, PCI DSS, and GDPR express their requirements as control statements: natural-language descriptions of security or operational obligations at a level of abstraction that does not specify the concrete system actions, configurations, or operational procedures required to satisfy them in any particular technology environment. Such controls are traditionally managed using spreadsheets or compliance dashboards that help track implementation and status, but these tools do not help in the actual implementation, continuous monitoring, and remediation that is required to meet compliance goals. For example, a control statement requiring that ‘all endpoints must be protected with up-to-date endpoint detection and response capabilities’ does not specify which EDR tool must be used, how the tool must be configured, what the threshold for ‘up-to-date’ is, how such tool is monitored, how evidence of compliance is collected, or what remediation action is taken when a non-compliant endpoint is detected. Organizations currently bridge this gap through manual processes: compliance teams translate control statements into internal policy documents, IT teams translate policy documents into configuration procedures, and auditors verify compliance through periodic manual review of logs and configuration records. This multi-step manual translation process is slow, expensive, and error-prone, and produces compliance posture that is assessed periodically rather than continuously enforced and monitored. There is a need for a technical system capable of automatically translating compliance control statements into executable operational workflows, continuously monitoring whether those workflows are producing compliant outcomes, collecting compliance evidence as a byproduct of normal operational execution, and surfacing compliance gaps as operational events that trigger remediation playbooks.

The present invention addresses this technical challenge through a compliance control mapping architecture integrated within the VICA system. The invention represents each applicable compliance control as a structured control object that encodes: a control identifier referencing the originating regulatory framework; a natural-language statement of the control requirement; a set of measurable operational outcomes that, if produced by system execution, satisfy the control requirement; and a set of evidence types specifying the categories of execution records that constitute proof of compliance. A control mapping engine associates control objects with one or more playbooks in the system's playbook library whose execution produces the operational outcomes specified in the control object, establishing a direct, machine-readable linkage between the regulatory obligation and the operational workflow that satisfies it. Alternatively, certain administrative controls may be managed via IT ticketing to track operational management actions, remediation activities, and evidence artifacts demonstrating compliance with the corresponding control object. This association may be established through pre-defined mappings maintained by the system for common framework-to-playbook relationships, through an AI model that identifies or generates appropriate playbooks for a given control object, or through administrator-defined mappings. A compliance monitoring engine continuously evaluates, for each control object, whether the associated playbooks are assigned to applicable entities, executing without error, and producing evidence artifacts of the required types, updating a compliance posture score on each relevant execution event rather than through periodic manual review. When a control's posture falls below a defined threshold, the system generates a compliance incident event that triggers a remediation playbook, converting what was previously a manual audit finding into an automatically detected and automatically remediated operational event. A reporting engine generates audit-ready compliance evidence packages by aggregating execution records and evidence artifacts produced as a byproduct of normal playbook execution, eliminating the need for retrospective manual data collection at audit time. In this way, the present invention transforms compliance from a periodic, manually-intensive assessment process into a continuously monitored, automatically enforced, and automatically evidenced operational function of the IT management system itself.

The system manages, monitors, and secures multiple domains concurrently, including users, devices, applications, SaaS services, cloud infrastructure, and user data, providing a unified operational view that replaces the collection of siloed point solutions previously required to address each domain separately.

In one embodiment, the present invention provides a unified IT and cybersecurity management system comprising a central controller and a plurality of endpoint agents deployed across the enterprise's managed devices. The controller serves as the primary orchestration hub, performing centralized monitoring, policy enforcement, event aggregation, and playbook-based workflow execution across a plurality of IT and cybersecurity domains. Each endpoint agent operates as a standalone service on its respective managed device, managing local resources, enforcing security and IT policies, collecting telemetry data, and executing playbook actions locally.

In one embodiment, the system extends its management and security capabilities into the browser runtime through a browser component controlled by the endpoint agent and executing within the browser process on the managed endpoint device. The browser component comprises a browser-level playbook engine that provides visibility into and control over in-browser events that are not accessible to an agent operating at the operating system level, including in-browser user activity, URL access, content interactions, and browser extension behavior. The browser component enforces security and IT policies within the browser execution context, performing URL filtering, content security controls, tracker removal, data loss prevention, and in-browser authentication. It also provides secure tunneling for access to corporate resources, replacing the need for a traditional VPN for browser-based access patterns. Playbook actions may be executed directly within the browser context through JavaScript, HTML, or WebAssembly, enabling the system to address security events that originate within the browser and that would not be externalized as operating system or network signals observable by conventional endpoint agents.

In one embodiment, the present invention provides a unified IT and cybersecurity management system comprising a central controller and a plurality of connectors, configured to interface with one or more managed systems through one or more application programming interfaces (APIs), the managed systems comprising cloud infrastructure such as IaaS, Software-as-a-Service (Saas) applications, or network appliances, such as storage and security appliances. Each connector communicates with the controller over a secured network connection and configured to retrieve telemetry information, monitor configuration and security state, and execute control actions on the managed systems in response to instructions generated by the playbook engine; The connectors enable the system to obtain telemetry, configuration state information, authentication events, and security-related activity from SaaS, cloud, and other environments and translate such information into the unified event schema used by the system. Through this mechanism, the system provides centralized visibility into SaaS application configurations, user activity, and security events across multiple services.

In certain embodiments, the connectors are further configured to enforce secure configuration policies and continuously evaluate SaaS, cloud, and other environment against defined security and compliance requirements. The connectors may detect anomalous or policy-violating behavior including, but not limited to, authentication attempts originating from unexpected geographic regions, logins occurring outside expected time windows, abnormal privilege escalation events, unusual data access patterns, or configuration changes that deviate from prescribed security baselines.

Upon detecting such conditions, the connector may generate normalized event records for analysis by the correlation engine and may initiate automated remediation actions through the playbook engine, including revoking sessions, enforcing multi-factor authentication, adjusting configuration settings, suspending accounts, or generating incident records or IT service tickets within the system.

In one embodiment, the playbook engine governs and automates the system's responses to IT and cybersecurity events through structured, executable playbooks. Each playbook comprises a trigger condition defining the event or condition that initiates execution, and a tree-structured sequence of action nodes through which execution proceeds. Each action node comprises one or more of the following: execution of a script or executable file in a supported scripting environment; invocation of API calls, creation of an IT ticket or notification directed to a designated assignee; web automation simulating user mouse movements and keyboard input to affect workflows in applications that do not expose a programmatic API; invocation of a machine learning model inference step; or a workflow control operation. Logical flow conditions at each action node evaluate the output of the preceding action to determine which subsequent node in the tree is executed, enabling the playbook to branch, loop, or terminate based on the results of its own execution. Trigger conditions may be scheduled, event-based, provisioning-related, feed-driven, or directly initiated by an administrator, end user, or external system.

Event-based triggers respond to a wide range of IT and cybersecurity events, including malware detection, anomalous login activity, disk utilization alerts, out-of-date software, and threat intelligence feed updates, among others.

In one embodiment, the playbook engine autonomously monitors events across all managed IT domains and, upon detection of an event satisfying a trigger condition, evaluates the event against logical conditions to determine a severity classification, creates an IT ticket comprising the event description and proposed response actions, and delivers notification to one or more designated assignees without human initiation. A response by a human assignee to the IT ticket constitutes a logical flow condition within the playbook, and the content of the assignee's response determines the subsequent action or sequence of actions the playbook engine executes. In an alternative embodiment, an AI model autonomously evaluates the IT ticket and selects a response, the selected response serving as the logical flow condition governing subsequent playbook execution. The AI model escalates the ticket to a human assignee when it determines that the event falls outside the scope of autonomous resolution. In a further embodiment, a playbook action comprises execution of a machine learning inference step whose output is evaluated as a logical flow condition, enabling the system to incorporate anomaly detection, classification, and large language model analysis directly into the decision logic of a playbook. This architecture enables the system to detect, prioritize, triage, and resolve a broad range of routine IT and cybersecurity events with minimal or no human intervention, reserving human judgment for events that genuinely require it.

In one embodiment, the system provides an AI-powered assistant interface through which end users and administrators interact with the system using natural language, via text, voice, or video input. The assistant processes user input using a large language model that incorporates organization-specific context, including the previously collected IT and cybersecurity telemetry data, user's device configuration, applicable enterprise policies, and the available playbook library, through MCP, in-context prompting, retrieval-augmented generation, or fine-tuning. In response to a user's request, the assistant returns a textual or voice response, triggers an appropriate playbook, or initiates an agentic workflow on the user's behalf, subject to authorization controls enforced by the controller. For requests that require administrative authorization before execution, the assistant triggers a playbook that creates an IT ticket directed to an administrator for approval, and communicates the outcome of the approval process to the user through the assistant interface. This interface enables end users to initiate IT and cybersecurity workflows through conversational interaction without requiring direct administrative access to the system, substantially reducing the volume of helpdesk escalations arising from routine IT requests.

In one embodiment, the controller maintains a compliance control mapping that associates each applicable compliance control with one or more playbooks whose execution produces the operational outcomes required to satisfy the control. Each compliance control is represented as a structured control object encoding a control identifier referencing the originating framework, a set of measurable operational outcomes, and a set of evidence types that constitute proof of compliance. The system supports automated operational compliance with recognized frameworks including SOC 2, ISO 27001, HIPAA, CMMC, PCI DSS, and GDPR. A compliance monitoring engine continuously evaluates, for each control object, whether the associated playbooks are executing without error and producing the required evidence artifacts, maintaining a compliance posture score updated on each relevant execution event. When a control's posture falls below a defined threshold, the system generates a compliance incident event and triggers a remediation playbook, converting compliance gaps from periodic audit findings into automatically detected and automatically remediated operational events. A reporting engine generates audit-ready compliance evidence packages by aggregating execution records and evidence artifacts produced as a byproduct of normal playbook execution, eliminating the need for retrospective manual data collection at audit time. In a further embodiment, an AI model identifies compliance gaps for which no existing playbook produces the required operational outcomes, and generates a proposed playbook specification to address each identified gap. In one embodiment, an association between applicable control objects and system IT tickets is made thereby providing tracking of operational management actions, remediation activities, and evidence artifacts demonstrating compliance with the corresponding control object.

In one embodiment, the controller employs rule-based or AI-driven mechanisms to recommend, select, or generate playbooks based on the organization's profile, including its industry, size, geographic distribution, applicable compliance requirements, the devices and applications in use, and telemetry data collected. An AI model trained or fine-tuned on industry security standards, regulatory framework documentation, and the organization's operational context may generate new playbooks tailored to specific organizational needs, with each AI-generated script subject to a multi-stage verification process that evaluates the script for logical consistency with its action specification and for the absence of code patterns associated with unauthorized or malicious behavior before the script is permitted to execute.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof.

For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, a processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions-which can be a set of instructions, an application, software-which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.” The accompanying figures include multiple cases of “computer networks” and other types of communication networks.

### BRIEF DESCRIPTION OF DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture of the overall system

FIG. 2 illustrates an example of a playbook workflow governing the system's actions in response to IT and cybersecurity events

FIG. 3 illustrates an embodiment of the higher-level system and flow

FIG. 4 illustrates an example of the data structures used to describe playbook objects

FIG. 5 illustrates an example of how playbooks are described visually

FIG. 6 illustrates an example of how the system is trained or finetuned.

FIG. 7 illustrates an example of how data collection and AI or rule-based models are used to select playbooks.

FIG. 8 is a block diagram of one embodiment of a computer system that may be used with the present invention.

### DETAILED DESCRIPTION

The present invention comprises a system and method that unify and automate modern information technology (IT) and cybersecurity management and monitoring as it pertains to multiple technological domains: users, devices, networks, applications, browsers, and data.

The present invention provides several significant advantages over traditional, siloed IT and cybersecurity management systems. Without wishing to be limited by a closed list, a non-limiting selection of such advantages include the following:

As a single platform, all domains are managed from a single pane of glass, in which data, insights, and controls from multiple security tools and domains are combined into a unified view. By consolidating multiple IT and security functions, such as remote monitoring and management (RMM) or mobile device management (MDM), anti-malware, endpoint detection and response (EDR), firewalls, VPNs, browser security, single sign on (SSO) solutions, patch management, and other common tools into a single platform, organizations may reduce their overall technology spend and simplify their IT infrastructure.

Unlike traditional tools, each providing its own proprietary data in a silo, in this unified platform all events can be monitored and correlated across the multiple domains, providing richer context and reducing security gaps.

Unlike traditional tools built for an era of on-premise and native applications, the Virtual IT and Cybersecurity Administrator implements built-in support for modern business applications that heavily rely on the cloud and the browser. To that end, it integrates with, manages, and monitors endpoint browsers and cloud-based applications and services. Utilizing these modern technologies allows the system to better observe important events that are not easily visible to legacy solutions, such as events taking place within the browser, and to replace the need for many legacy tools, such as VPNs and firewalls, with browser-connected or cloud-based IT and security alternatives.

By automating responses to IT and security events through playbooks, the system significantly reduces the need for manual intervention, allowing much faster response to incidents than manual processes, freeing IT staff to focus on more strategic tasks. The Virtual IT and Cybersecurity Administrator's ability to rapidly and consistently execute predefined actions in response to security threats enhances an organization's overall security stance. Automated playbook execution minimizes the risk of mistakes that can occur with manual processes, potentially leading to fewer security incidents and IT disruptions.

The system incorporates a regulatory and security control mapping framework that translates requirements from regulatory, contractual, or organizational standards (including but not limited to SOC 2, ISO 27001, NIST, CIS benchmarks, HIPAA, PCI-DSS, CMMC) into actionable operational controls within the platform. Regulatory requirements may be represented as structured control objects defining operational outcomes, monitoring conditions, configuration requirements, and associated evidence artifacts. The system maps such control objects to one or more playbooks whose execution produces, verifies, or maintains the required operational outcomes. Through this mapping, the system continuously monitors relevant events, configurations, and activities across managed domains, including users, devices, networks, applications, browsers, and data, to determine whether the control conditions are satisfied. When deviations are detected, the system may automatically initiate remediation actions through the playbook engine, including enforcing policies, adjusting configurations, revoking privileges, updating software components, generating alerts, or creating IT service tickets for further investigation. The system may further collect and store evidence artifacts generated during playbook execution, including logs, configuration snapshots, system states, and execution records, enabling organizations to demonstrate compliance and facilitate internal governance or third-party audits.

The Virtual IT and Cybersecurity Administrator's ability to execute actions across various platforms and applications through scripting and web automation provides extensive flexibility in managing diverse IT environments, which comprise multiple devices and operating systems.

Unlike traditional, static solutions, AI-driven playbook recommendation and generation capabilities allow the system to evolve and adapt to changing organizational needs and emerging threats without constant manual updates. The AI-driven approach to playbook generation and optimization positions the system to adapt to future technological changes and emerging threats. As the system collects more data over time, it may develop the ability to predict and preemptively address potential IT and security issues.

The AI-driven playbook approach also allows automated adherence to best practices and compliance requirements that can be created or selected based on each organization's preferences, and allows straightforward attestation to meeting such requirements.

By incorporating AI and machine learning models into the playbook actions the system can detect issues such as anomalous behavior and identify and mitigate potential issues before they escalate into significant problems.

The integration of an LLM-powered assistant provides a user-friendly interface for employees to resolve IT issues, potentially further reducing helpdesk tickets and improving productivity.

The multi-tenant architecture enables the system to efficiently manage multiple organizations while maintaining data isolation, making it suitable for managed service providers or large enterprises with multiple divisions.

By encoding IT and security processes into playbooks, organizations can better retain institutional knowledge, reducing reliance on specific individuals. The ability to create and modify playbooks allows organizations to tailor the system to their specific needs and processes. The system's ability to interface with various enterprise services and endpoints suggests strong potential for integration with existing IT infrastructure and tools.

These exemplary, illustrative advantages position the invention as a transformative solution in the field of IT and cybersecurity management, offering organizations a powerful tool to navigate the increasingly complex digital landscape.

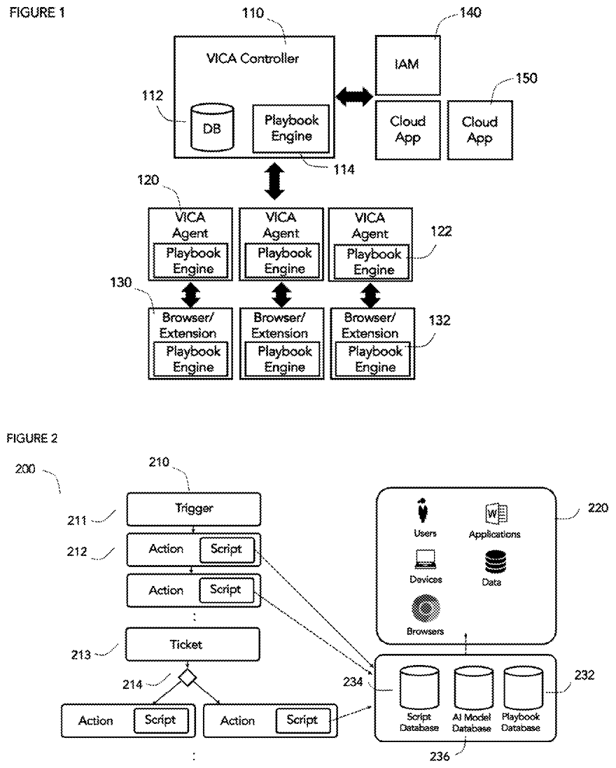

FIG. 1 is a diagram of some embodiments of the principal system components. It illustrates the hierarchical architecture of the Virtual IT and Cybersecurity Administrator (VICA) system and its integration with enterprise services and endpoints. The figure depicts the core cloud VICA Controller (‘Controller’) 110 and its relationships over a network with various corporate systems, comprising a corporate identity management system 140 and a plurality of cloud applications 150 used by the enterprise end users, as non-limiting examples.

In some embodiments, the central VICA controller 110 serves as the primary orchestration hub, providing centralized monitoring and control; playbook creation and management; policy enforcement; event aggregation and processing; and security monitoring and response coordination. The controller may be implemented as a physical server, a virtual server, or a containerized instance. The controller may further comprise one or more computing instances, which may be distributed across multiple physical or virtual computing environments. The controller may be executed on a single computing device or across a plurality of networked computing devices, wherein each instance may operate independently or in coordination with other instances to perform control operations.

In some embodiments, a plurality of VICA agents 120 are deployed on computing devices across the enterprise infrastructure, where each agent operates as a standalone service on managed endpoints, responsible for managing local resources, configurations, and applications, collecting telemetry and system state information, enforcing security policies, enforcing and IT policies, and reporting status and events to the Controller 110 over a network. In some embodiments, the endpoints consist of PCs, servers, and mobile devices, each running one of several operating systems, including Windows, MacOS, Linux, ChromeOS, Android, or iOS. The network connection is secured by using a protocol such as TLS and authenticated using one of several standard authentication techniques, such as X.509 certificates, tokens, OIDC, or other industry standard methods.

In some embodiments, the Controller is connected to the corporate identity and access management system (IAM) 140, synchronizing user identities between the system using the IAM's APIs or via standard protocols such as System for Cross-Domain Identity Management (SCIM). The Controller also optionally implements Connectors to interface with corporate SaaS applications 150 to provide services such as single sign on (SSO) functionality using OAuth, SAML, OIDC, and other standard protocols, act as a reverse proxy to inspect and secure traffic going in and out of these applications, detect security events through the use of the applications' APIs (for example, login from a suspicious location), and monitor applications usage. In some embodiments, the Connectors further interface with network infrastructure and other managed systems, including networking and storage devices, security appliances such as firewalls, cloud infrastructure including Infrastructure-as-a-Service (IaaS) and Platform-as-a-Service (PaaS), and other networked services, through their respective APIs, management interfaces, or standard network protocols to obtain telemetry, monitor configuration and security state, and perform control actions.

In some embodiments, a custom Internet browser or browser extension 130 on the endpoint is controlled by the agent 120. Such browser component is capable of injecting JavaScript code or hooking into browser activity to inspect and filter certain domains or URLs, remove trackers and other potentially hazardous web elements, control other browser extensions, secure access to corporate resources by implementing a tunneling protocol, authenticate and authorize users in the browser, enforce IT policies at the browser level, perform data loss prevention, and monitor activity in the browser.

In some embodiments, the VICA system performs actions responsive to events detected from endpoints or cloud services. These events and responses are governed by ‘playbooks’. Playbooks are modular workflows designed to handle IT and security events that are captured by the VICA system components and serve as a comprehensive framework for dealing with various operational and security-related incidents. The goal of such playbooks is to ensure that every potential issue, whether it be an operational failure, security breach, or anomaly, is addressed promptly and in an automated fashion. Playbooks ensure that IT administrators and cybersecurity professionals are able to manage a wide range of events, from routine maintenance to complex security incidents, and do so remotely, in a timely manner, and in an automated fashion requiring minimum or no human intervention.

In some embodiments, each controller 110 comprises a database 112 for storing data such as user and device information, IT and security logs, and system settings, and of a playbook engine 114 that can perform workflows consisting of executing actions responsive to triggers corresponding to IT and cybersecurity events.

In some embodiments, each VICA agent 120 comprises a playbook engine 122 executing actions locally on agent devices responsive to IT and cybersecurity events. In some embodiments, each browser or browser extension 130 associated with a VICA agent 120 also comprises a playbook engine 132 executing actions within the browser, including actions prescribed by HTML code, Javascript code, or Web Assembly.

In some embodiments, the system 110 supports multi-tenancy, managing multiple individual sites or organizations. Such multi-tenancy is achieved by splitting the system into containers or other types of logically distinct instances per each site or customer. A shared database remains to store and collect required global setup, telemetry and event data.

Unlike prior systems in which each security tool generates events in its own proprietary schema and stores them in an isolated data store, the VICA Controller 110 maintains a unified event schema to which all domain-specific event streams are normalized upon ingestion. This normalization step translates disparate, vendor-specific event formats into a common internal representation that encodes, at a minimum: event type, originating domain, entity identifier, timestamp, and severity score. The Controller 110 applies a correlation engine that operates over this normalized event stream to identify multi-domain event sequences that together constitute a threat pattern not detectable by examining any single domain in isolation. For example, a sequence comprising (i) an anomalous authentication event at the identity layer, (ii) a concurrent browser-level access to an unusual URL, and (iii) a process-creation event on the associated endpoint device may individually appear benign in their respective siloed systems but, when correlated across domains in the unified event schema, satisfy a composite threat signature triggering a playbook response. The technical improvement achieved by this architecture is the ability to detect and respond to multi-stage attack patterns that exploit the boundary between security domains. This class of threats that is structurally invisible to any collection of per-domain point solutions operating independently.

The event streams may include but are not limited to endpoint telemetry from VICA agents 120, browser-level events from browser component 130, identity and access events from IAM system 140, application-level events from SaaS applications 150, and, in some embodiments, events obtained from network infrastructure and other managed systems, including networking and storage devices, security appliances such as firewalls, cloud infrastructure including Infrastructure-as-a-Service (IaaS) and Platform-as-a-Service (PaaS), and other networked services.

The browser playbook engine 132 addresses a fundamental architectural limitation of conventional endpoint security agents: actions and events occurring within the execution context of a browser process are not accessible to an agent operating at the operating system level. Non-limiting examples of such browser actions include JavaScript execution sequences, Document Object Model (DOM) interactions, in-browser credential entry, web application session state, and inter-extension communications. An OS-level agent can observe that a browser process is running and may inspect network traffic at the OS layer, but cannot natively observe the content of in-browser events, the execution of page-level scripts, or the behavior of browser extensions without cooperation from within the browser runtime itself. The browser playbook engine 132, executing within the browser process through a native browser extension or through a purpose-built browser, has direct access to these browser-internal events and can both monitor them and execute responsive playbook actions within the same execution context where the events originate. This access is architecturally distinct from, and not achievable by, any combination of OS-level monitoring agents and network proxies, because it provides visibility into and control over the in-browser execution environment before events are externalized as network traffic or OS-level signals. Non-limiting examples of playbook actions include blocking a URL, injecting content security controls, intercepting a credential entry, or enforcing a data loss prevention policy.

FIG. 2 illustrates a system 200, featuring an architecture of a playbook 210. The figure depicts the logical organization of playbooks. Each playbook maintains a consistent internal structure comprising a trigger 211 that defines activation conditions. Activation conditions consist of security events, such as detection of malware, user login, process creation, assignment of certain document permissions, a threat feed, and other cybersecurity-related events, as well as IT events such as disk utilization issues, or out-of-date software components. Playbook trigger conditions may be scheduled, event-based, or initiated directly by the administrator, end user, or by external systems. For example, a playbook may be triggered due to a malware that has been detected on an endpoint, triggered explicitly by the administrator, or it may be triggered as a result of an IT support ticket opened by an end user, such as requesting a security exception or requesting access to an application or web site.

In addition to the trigger condition, playbooks comprise one or more action components 212, 213, a series of one or more executable steps to be undertaken in response to the trigger. Once a playbook is triggered, it executes a sequence of actions that can be represented as a tree structure. In some embodiments, each action consists of a sequence of operations encapsulated in a script 212. A second type of action consists of the creation of IT ‘tickets’, or notifications 213. In some embodiments, logical flow conditions 214 determine the next action based on the output of the previous actions. Logical flow conditions include Boolean expression or scripts that return the next action to be taken in the playbook, such next step may terminate the playbook execution, continue its execution, choose the next action to take in the playbook tree, or wait on a response to an IT ticket. For example, depending on the return value of a first action, such as detecting a suspicious login, a playbook may determine whether to ignore it and terminate playbook execution, execute a second action of blocking the suspect user, or execute a third action of opening an IT ticket and waiting for administrator feedback before continuing down the playbook flow.

Actions 212 may include a set of one or more scripts to be executed along with optional parameters. Each such script may consist of a shell script (such as Bash, PowerShell, Python, and other types of shells) or an executable file. In some embodiments, multiple script variants may be used in conjunction to support multiple platforms (for example, MacOS and Windows). In some embodiments, scripts receive input values and report their output to the subsequent scripts and to the controller.

Each action or script 212 has a target associated with an IT domain 220, associating it with users, devices, applications, data, or browsers. For example, an action may execute locally on an endpoint device 230, such as cleaning up files when disk space is low, while another action may run in the cloud to interface with SaaS applications through APIs and perform automatic configuration of certain application settings. If executed on an endpoint device or browser, a playbook is first transmitted over the network to the respective agent and or browser to be executed locally.

In some embodiments, each playbook or script is stored and retrieved from a database or databases maintained by the controller. Such databases include the specification of each playbook 232, the content of the scripts associated with the playbooks (shown in script database 234), and a repository of Artificial Intelligence (AI) models 236 that can be incorporated into scripts.

In some embodiments, a playbook action may invoke web automation as a means to affect certain configuration or workflow. Web automation may utilize tools such as Playwright or Puppeteer, or Large Language Model (LLM)-based methods, such as Claude PC Control and other techniques to affect a desired workflow. For example, to configure settings of a specific web application the agent or the Controller may simulate the desired mouse movements and keyboard input based on the rendering of the application in a browser.

In some embodiments, an action may consist of executing an AI model, a machine learning training or inference responsive to input gathered by the script or previously run scripts, as well as contextual data stored in the Controller's database. Such action may return a value that will serve as a logical condition governing the subsequent playbook action flow, or in some embodiments trigger a second playbook. In some embodiments, such actions are associated with scripts that detect anomalous behavior of time sequences using a rule base, supervised learning methods, such as SVMs, unsupervised models, neural network-based techniques, such as autoencoders and LSTMs, or LLMs for parsing log data or images. For example, an action may trigger a script in response to a user login event, run an inference step comprising anomaly detection based on the most recent event correlated with previous login events' time and location as context. If such a step concludes an anomalous pattern is present (for example, an employee has logged in at an unusual time or location) a corresponding mitigating action may be taken by the playbook. Such action may involve automatic blocking of this user or the creation of an IT ticket if further human intervention is required. Such AI model may run on the controller or on the endpoint, and may consist of executable code, a shell script, web assembly code running in the browser, or an API call to a large action model (LLM) or other service providing inference capabilities.

Ticket actions 213 allow the creation of IT tickets, which consist of notifying or assigning a task to the system's administrator or to other users of the system (“assignees”); assigning severity; logging activity; or initiating an approval workflow, whereby certain subsequent actions require human or agentic intervention, such intervention used as input to a logical condition determining further execution of playbook actions. Notification of assignee may be carried out via email, text, Slack, mobile or web push notification, or other standard methods. For example, a trigger responsive to a periodic scan of a cloud application discovers a suspicious login attempt and a ticket is opened based on the scan result, at which point the IT administrator may respond to the ticket and affect several different subsequent flows. For example, the administrator may choose to ignore the event, temporarily block the user from accessing corporate applications, or remove the user from the system, each triggering a different chain of subsequent actions. Preferably, some responses to an IT ticket are fully autonomous decisions based on a rule base or a machine learning model with no human interaction, such as analyzing user activity or location in response to a trigger, processing such data using a machine learning model to identify anomalies, followed by selecting the desired subsequent action flow to mitigate such incidents. In some embodiments, the inference step is encapsulated in an action script triggered by the IT ticket.

In some embodiments, each playbook or script is digitally signed using standard industry methods, such as using its SHA256 digest encrypted with the Controller's private key. The agent verifies the signature before executing a script against the Controller's public key before allowing it to be executed. Alternatively, each script digest may reside on a separate public or private cloud or utilize other Multi Party Compute (MPC) techniques, eliminating single points of failure and allowing each enterprise customer to fully control what code is run.

In some embodiments, the playbook trigger events may be initiated by a system user through a chat or voice assistant interface. Such triggers are transcribed if necessary and sent over for processing by an agentic LLM model capable of triggering the appropriate playbook in response to the textual prompt. The underlying LLM may be fine-tuned with corporate-specific configuration stored in the LLM, such as the specific setup of the user's local machine, applications used, and system settings, as well documentation of the relevant applications and operating system, and playbook flows and instructions. This can be implemented with MCP, Retrieval Augmented Generation (RAG) interface, with fine-tuning techniques such as LoRA, or using in-context and prompt engineering.

For example, an end user may ask the LLM-powered assistant to install a software application they would like to use, such as Adobe Photoshop. While the VICA system may have a policy not allowing end users to install any software for security reasons, as enforced by the VICA agent, the assistant can trigger an agentic workflow and in conjunction with the playbook system perform a software installation process on the users' behalf even though the user does not have administrative permissions to do so. Based on each enterprise policy, such action can be taken autonomously or require administrator approval. If approval is required, the playbook will create an IT ticket for the administrator to review and approve. Alternatively, the assistant may suggest to the end user to install or use a different corporate-compliant application, such as Canva.

Another example involves asking the assistant for a forgotten password. If a user forgets the password to an application, they might type or say, “I forgot my password for my work email, what should I do?” The assistant would initiate an agentic workflow first verifying the user's identity through secure authentication methods, ensuring that the request is legitimate. Once confirmed, it would walk the user through the process of obtaining the password or trigger a playbook implementing password recovery. If the user encounters additional hurdles, such as not having access to the recovery email or phone, the assistant would escalate the issue via the ticket creation action, ensuring that the user can regain access to their account promptly. This process helps users regain access to their systems quickly without the need for waiting on human intervention, all while ensuring security protocols are followed throughout the process. Other examples of common end user interactions with the LLM-powered assistant can include reporting a slow device or connection, asking to find or restoring lost data, or encountering the ‘blue screen of death’.

In some embodiments, in case a user informs the assistant of an IT or cybersecurity issue that is catastrophic or falls out of scope of the system's capabilities or terms, the VICA system may run a playbook that reimages the endpoint and restores its data and settings based on stored backup data and endpoint settings information maintained by the Controller. In some cases, such as in case of a hardware failure, the VICA system may automatically initiate a playbook whereby a new device is shipped to the affected user with a fully restored image, thereby substantially reducing downtime and improving productivity.

In some embodiments, the hierarchical JSON structure of playbook objects enables three specific technical functions that arise directly from the structure of the data representation and cannot be achieved with flat or unstructured playbook representations. First, playbook inheritance: an entity (for example, a user, device, or user group) inherits the playbooks assigned to its parent group in the organizational hierarchy. Because playbooks and their assignments are encoded as JSON objects with explicit parent-child references, the Controller 110 can traverse the inheritance tree to assemble the complete set of effective playbooks for any entity without requiring each playbook to be explicitly duplicated at each hierarchical level. Second, conflict detection: when two playbooks prescribe different actions in response to the same trigger condition, the Controller 110 detects the conflict by analyzing the trigger conditions and action sequences of co-assigned playbooks as parsed JSON objects, and can either surface the conflict to the administrator or resolve it programmatically according to a priority ordering encoded in the playbook metadata. Third, atomic rollback: because each playbook version is stored as a discrete, versioned JSON object, the Controller 110 can revert any entity or group of entities to a prior playbook state by reassigning the prior version object, without requiring a replay or reconstruction of the prior state. This makes rollback deterministic and auditable: the system can produce a complete record of which playbook version was active for any entity at any point in time by reference to the versioned JSON objects and their assignment timestamps.

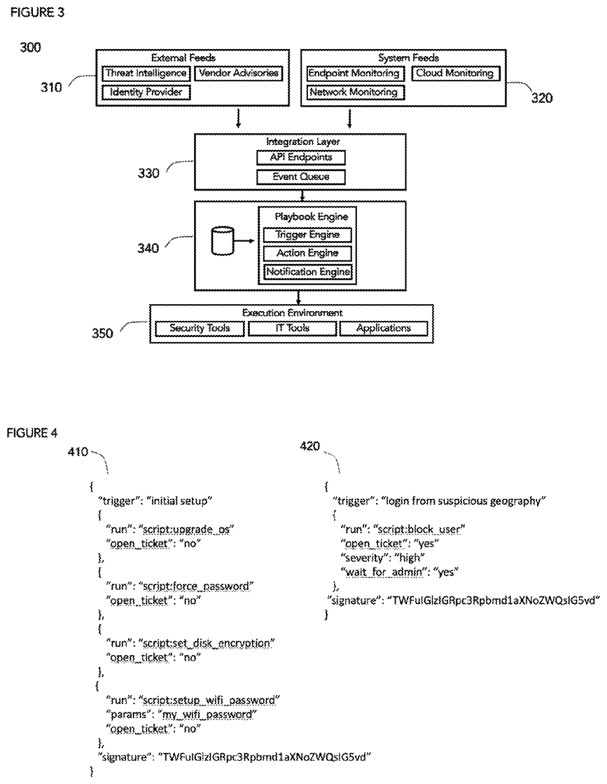

FIG. 3 illustrates an embodiment of the higher-level system flow consisting of the VICA system architecture comprising an Integration Layer 330 that serves as the central hub for ingesting data from External Feeds 310 and System Feeds 320. The External Feeds include Threat Intelligence, Vendor Advisories, and Identity Provider services, while the System Feeds include Endpoint Monitoring, Cloud Monitoring, Network Monitoring, and other system-level monitoring capabilities. The Integration Layer 330 exposes API Endpoints and an Event Queue communicating with the Playbook Engine 340 comprising a Trigger Engine, an Action Engine, and a Notification Engine to receive and process the ingested events and execute the Playbook Engine. Such a Playbook Engine may run on different targets, such as being executed by the VICA Controller in a cloud, executed by a VICA agent on an endpoint, or by a VICA browser on an endpoint. The Trigger Engine subsequently monitors incoming events. When a trigger condition is met, the Action Engine is invoked to execute the corresponding playbook. The playbook actions are executed within the Execution Environment 350 that provides access to Security Tools, IT Tools, and Applications.

In some embodiments, the playbooks along with their hierarchical structure are defined as JSON objects. FIG. 4 illustrates examples for such JSON objects 410-420. For example, playbook 410 described by a JSON object demonstrates a workflow triggered upon initial setup of a device, whereupon it is performing a few basic setup actions relating to the underlying operating system, including an operating system upgrade, enforcement of a password policy, enabling disk encryption, and configuring the Wi-Fi network. Playbook 420 is an example of an event-based action triggered in response to a security incident detected by the agent, whereby a suspicious activity had been spotted. Per this playbook, an IT ticket is created to notify the administrator and await the administrator's decision on how to mitigate this event.

In some embodiments, the JSON structure also determines which events are collected, logged, or communicated to the VICA. For example, in the context of capturing security-related events through Endpoint Detection and Response (EDR) functionality, some VICA controllers may determine that they wish to track registry events, but do not wish to track or report events relating to copying files to a USB drive, or track device reboots.

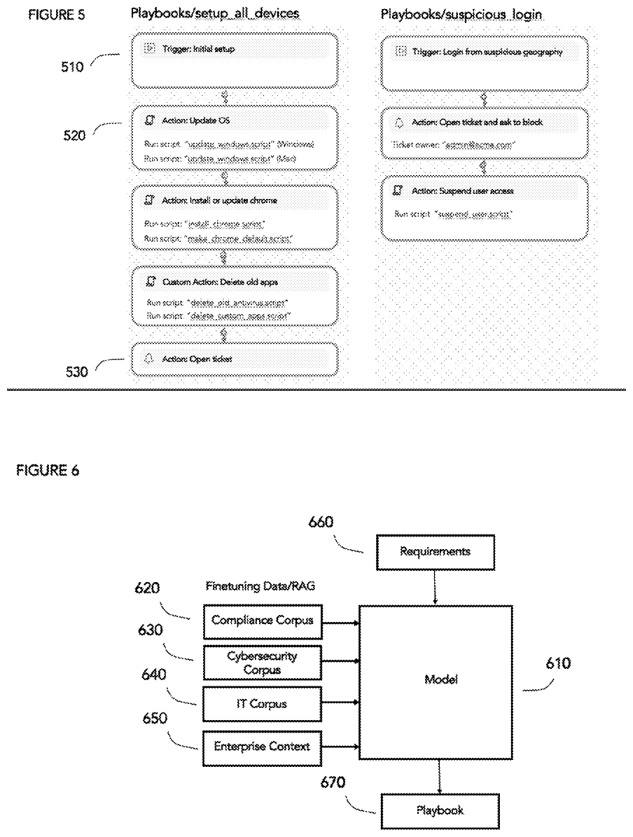

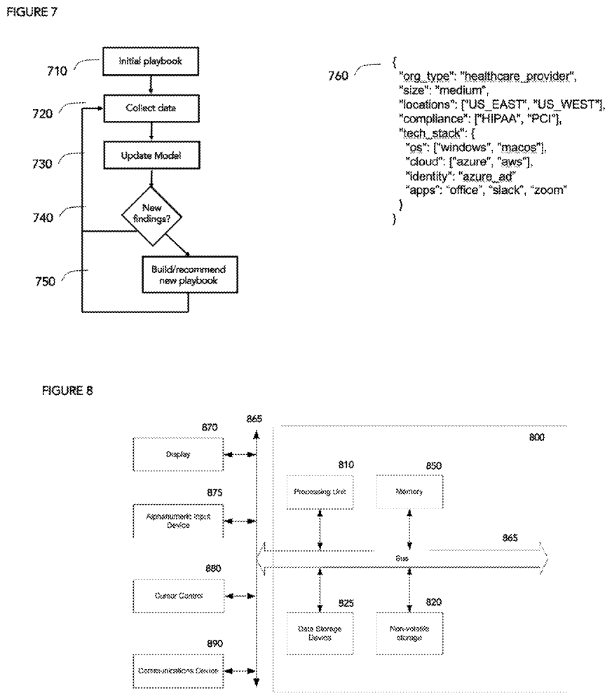

FIG. 5 illustrates an embodiment consisting of a flow chart-like interface for viewing and editing playbooks. In some embodiments, such an interface displaying configurable trigger events 510, configurable actions to be taken in response to said trigger event 520 with custom parameters, and ticketing, logging, or reporting actions 530, is available to the administrator for defining playbooks.

In some embodiments, the system checks that all playbooks assigned to an entity are consistent. Multiple playbooks may be assigned to the same entity, such as a user, user group, or a device, due to the hierarchical group structure whereby entities inherit their playbooks based on group affiliation or label. If two playbooks prescribe different actions the Controller will alert the administrator of the conflict and ask for it to be resolved. Alternatively, the Controller may assign priority to each playbook and resolve conflicts by priority.

In some embodiments, newly created or edited playbooks support phased propagation, using techniques such as “canary releases”, propagation to a small pre-defined subset of users or devices, or a statistical, phased roll-out, such as initially 10% of the population, then 20%, 50%, and 100%. Phased playbooks offer built-in best practices that are important as they can identify any undesired impact of any such roll-out before it can affect the entire organization. Rollbacks may be handled by implementing playbooks that specifically reverse, or roll back, the actions taken by new or edited playbooks.

In some embodiments, the system incorporates a fine-tuned Large Language (LLM) or Small Language Model (SLM) to review the structure of the playbooks or provide a concise summary of a playbook content and purpose to the system's administrator, including for example details of the key settings prescribed by the playbook as their relevance to the organization's contextual cybersecurity, IT, and compliance environment.

FIG. 6 illustrates the workflow related to creation and selection of playbooks. In one embodiment, the VICA system consists of a model 610, which may consist of a large language model (LLM) or Small Language Model (SLM), or other machine learning or rule-based models trained or finetuned on datasets, which includes industry standards (e.g., NIST, ISO 27001) and regulatory guidelines (e.g., GDPR, CCPA, HIPAA) 620, documentation for widely used IT and cybersecurity tools and processes 630 and 540, and enterprise context such as a list of its assets as gathered by the Controller 650. The model is fine-tuned to specialize in IT and cybersecurity workflows, enabling it to generate actionable recommendations based on specific business attributes. If fine-tuning LLMs, fine-tuning may be performed in-context, using RAG, LoRA, or using other common techniques. Upon receiving input data 660, such as the business's industry, size, geographic location, and the tools it uses, the data processing engine normalizes and encodes this information. The model processes the input to identify relevant security threats, compliance obligations, and best practices. For example, the model can recommend PCI DSS compliance workflows for a retail business. The model will then match the requirements with a set of playbooks that most closely match such requirements and recommend or autonomously select such playbooks 670.

FIG. 7 illustrates the workflow related to creation, evolution, and selection of playbooks. In some embodiments, the system starts with a set of playbooks 710 selected by the administrator or preset by the system. In some embodiments, the system first collects data from the admin and/or from the endpoint sensors 720. Based on the data collected, the system can automatically recommend or put in place certain preconfigured playbooks, based on one or more of the following: business type, business size, industry, geographical distribution, compliance requirements (e.g. SOC 2, CMMC, HIPAA, etc.), devices and operating systems in use, applications in use by business employees, and gathered telemetry data.

For example, if serving a US-based medical clinic, HIPAA-compliant security and privacy controls are likely to be required. Playbooks provide structured actions and attestations that support HIPAA compliance by ensuring that security policies and controls are consistently implemented and enforced. These may include items such as a mandatory Employee Security Awareness Training that may be mandated by the playbook for all new hires, as well as annual refresher courses on cybersecurity best practices and HIPAA security rules. Playbooks can run training courses and log training completion via its browser or browser extensions and use it as attestations of compliance. In some embodiments, playbooks may instruct the browser extension to make certain application access contingent on completion of said training. To meet another aspect of HIPAA compliance, an Antivirus and Endpoint Detection & Response (EDR) playbook ensures that all endpoints are protected with up-to-date antivirus software and EDR solutions, specifying regular scans, automated threat response mechanisms, and incident reporting procedures. Compliance is demonstrated through antivirus scan logs, EDR alerts, and remediation reports. A Password Policy playbook enforces strong password creation, multifactor authentication (MFA), and periodic password changes, ensuring compliance by maintaining logs of policy enforcement and user authentication events. Each of these playbooks provides documented evidence that security measures are actively managed, helping organizations meet HIPAA requirements through clear, repeatable processes and audit-ready attestations.

Preferably, the system continuously receives updates to its preset playbooks 720. Some updates are performed manually by the administrator, while some may be based on continuous collection of telemetry data and various external feeds, such as security threat feeds. Based on these and the underlying rule engine, the system will profile its users 760 and periodically update its profile and may subsequently change recommendations 750 for playbooks accordingly. For example, if many high-risk or unwanted applications are installed by end users, the model may suggest blocking certain application categories or taking away the ability of users to install software independently.

Preferably, the system's rule engine can generate new, custom playbooks based on specific business information including one or more of the following: business type, business size, industry, geographical distribution, compliance requirements (e.g. SOC2, CMMC, HIPAA, etc.), devices and operating systems in use, applications in use by business employees, threat or IT feed information, and gathered telemetry data. Based on rule-based or fine-tuned LLM models, a policy will be created with the appropriate settings and controls for the environment.

Preferably, data collected may include but is not limited to performance metrics, error patterns, user feedback, and execution success rates to measure effectiveness of current playbook. Additionally, this data may be combined with new threat updates, new compliance requirement updates, evolving best practices, new scripts, and emerging threat response.

In some embodiments, the system employs a multi-stage AI architecture for playbook script generation. By analyzing system requirements and execution context it can generate an agentic script that implements the desired functionality and runs various guardrails to ensure such script is not harmful.

Preferably, if the system uses LLMs to generate or modify a playbook or a script the system will perform multi-stage verification to eliminate errors or AI hallucinations that could compromise cybersecurity or IT uptime. These verification methods may include a second model verifying logical consistency of the generated playbook, generating multiple responses and using majority voting between them, and other common methods.

In some embodiments, the multi-stage verification process for AI-generated scripts operates as follows. In a first stage, an AI model generates a candidate script in response to a playbook action specification. The model may be a large language model (LLM) or a specialized code-generation model, for example. The candidate script is not executed at this stage. In a second stage, the candidate script is submitted to a verification process that evaluates the script against one or more of the following criteria: (i) logical consistency with the action specification that prompted its generation; (ii) absence of operations that would exceed the scope of permissions defined in the playbook action specification; (iii) absence of code patterns associated with known malicious behaviors, including but not limited to unauthorized network communications, file system modifications outside defined scopes, and privilege escalation sequences; and (iv) syntactic validity for the target execution environment. Only a script that satisfies all applicable verification criteria proceeds to execution. A script that fails any criterion is either discarded, returned to the generation stage with failure annotations for regeneration, or flagged for human administrator review, depending on the failure type and severity.

In some embodiments, the verification stage employs a model instance that is distinct from the generation model, such that the generator and verifier do not share intermediate state or context beyond the generated script and its specification. This separation is a deliberate architectural choice to reduce the probability that an error or adversarial input that influenced the generator's output will also influence the verifier's assessment, since two independent model instances processing the same input are less likely to produce the same erroneous output than a single model asked to self-verify. In other embodiments, the verification stage employs the same underlying model as the generation stage but with a distinct system prompt and without access to the generation-stage conversation context, achieving functional independence through context isolation rather than model separation. In further embodiments, the system generates a plurality of candidate scripts using the same or different generation parameters and applies a majority-vote or consensus mechanism among the candidates, advancing to the verification stage only the candidate selected by the majority, thereby reducing the influence of any single generation anomaly on the final executed script.

In some embodiments, each script that passes the multi-stage verification process is digitally signed by the Controller 110 using a signing key associated with the verified script version, and the signature is verified by the receiving agent 120 before execution, as described above with respect to playbook signing. This ensures that even if a verified script is intercepted or modified in transit, the modification is detected before the script is executed on the endpoint. The combination of AI-based pre-execution verification and cryptographic post-transmission verification provides a two-layer technical defense against execution of unauthorized or malicious script content within the playbook system.

Preferably, the system can switch between or add playbooks throughout the lifecycle of the user or device. A typical dynamic workflow would involve a basic setup and instrumentation of users and devices, followed by a period consisting of collection of telemetry data. Once enough data has been collected, the system can generate a playbook based on the collected data.

In some embodiments, the VICA system implements a compliance control mapping architecture that translates regulatory and security control statements into operational playbook specifications. In this architecture, each compliance control applicable to the organization is represented as a structured control object comprising: a control identifier referencing the originating framework (e.g., SOC 2CC 6.1, CMMC, HIPAA § 164.312(a)(1)); a natural-language statement of the control requirement; a set of one or more measurable operational outcomes that, if achieved and maintained, satisfy the control requirement; and a set of evidence types (for example, log records, configuration state snapshots, execution records, or attestations), that demonstrate achievement of those outcomes. The control object is stored in the Controller's database 112 alongside the playbook objects and is associated with one or more playbooks whose execution produces the operational outcomes required by the control.

In some embodiments, the association between a control object and its corresponding playbooks is established through one or more of the following mechanisms: (i) a pre-defined mapping maintained by the system for common framework-control-to-playbook associations (e.g., a password policy enforcement playbook is pre-mapped to HIPAA § 164.312(d) and NIST SP 800-53 IA-5 controls); (ii) an AI model that, given a control object, identifies the playbooks in the system's playbook library whose action specifications most closely correspond to the operational outcomes required by the control, and generates a proposed mapping for administrator review; or (iii) administrator-defined mappings created through the system's management interface. Without wishing to be limited in any way, the AI model may be an LLM fine-tuned on regulatory framework documentation and the organization's playbook library.

In some embodiments, the AI model is further capable of identifying gaps, such as controls for which no existing playbook in the library is capable of producing the required operational outcomes, and generating a proposed new playbook specification to address the gap, which may then be refined by the administrator or autonomously instantiated subject to multi-stage verification as described herein.

In some embodiments, the VICA system continuously monitors compliance posture by evaluating, for each control object, whether the playbooks associated with that control are currently assigned to the applicable entities, are executing without error, and are producing execution records and evidence artifacts that satisfy the evidence type requirements of the control. The Controller 110 maintains a compliance posture score for each control, updated on each execution event of a relevant playbook, and generates a compliance posture dashboard accessible to the administrator. When a control's posture score falls below a threshold, the Controller 110 generates a compliance incident event that triggers a remediation playbook, which may include alerting the administrator, re-executing the failed playbook on the non-compliant entities, or creating an IT ticket for manual review. The score may fall below a threshold for a variety of reasons, including but not limited to, failure of a playbook to execute on a subset of in-scope endpoints, or because a required evidence artifact has not been generated within the required period.

In some embodiments, the VICA system generates audit-ready compliance reports by aggregating, for each control object, the execution records, configuration state snapshots, and other evidence artifacts produced by the associated playbooks over a specified reporting period. These reports are generated programmatically from structured data produced as a byproduct of normal playbook execution, without requiring manual data collection or retrospective reconstruction of operational history. In some embodiments, the system can produce evidence packages formatted to the evidentiary requirements of specific audit frameworks, including the assertion format required by SOC 2 Type II assessments, the control implementation documentation format required by ISO 27001 certification audits, CMMC PO&AM, and the required and addressable implementation specification format of the HIPAA Security Rule.

In some embodiments, the VICA system implements an autonomous event-to-response pipeline that executes entirely within the detection latency of the monitoring system, without any human triage step intervening between the detection of an event and the delivery of a structured response artifact to the appropriate system component or assignee. In prior-art IT management systems, the process of translating a detected event into a structured response—comprising severity assessment, response action identification, ticket generation, and assignee notification—required human analyst review at one or more stages, introducing a latency class that is bounded not by the processing speed of the computing system but by the availability and response time of human personnel. This latency class is structurally unbounded: it is not reducible by increasing computing resources, because it does not arise from a computational bottleneck. The VICA system eliminates this structurally unbounded latency class by encoding the translation from detected event to structured IT ticket as a sequence of computational operations executed by the playbook engine. Upon detection of an event satisfying a trigger condition, the playbook engine translates the event into a normalized event record in the unified event schema, evaluates the record against logical conditions to produce a severity classification, generates a structured IT ticket comprising the normalized event record and one or more candidate response actions drawn from the associated playbook, and delivers the ticket to designated assignees, all within the detection cycle of the monitoring system. The technical improvement is therefore architectural: the pipeline has a computational upper bound on its latency rather than a human-mediated upper bound, enabling the system to respond to security events at a speed commensurate with the speed at which threats propagate through the managed IT environment.

In some embodiments, the VICA system employs an AI model to autonomously evaluate IT tickets and select response actions without human intervention for events falling within the model's resolution scope. In this architecture, each IT ticket is represented as a structured ticket object comprising: a normalized event record in the unified event schema; a severity classification produced by the playbook engine; one or more candidate response actions identified by the associated playbook; and contextual data drawn from the Controller's database, including the historical event record for the affected entity, the entity's current device and application state, and prior ticket resolution outcomes for similar events. The AI model receives the structured ticket object as input and executes an inference step that maps the ticket object to a response action drawn from the set of candidate actions encoded in the ticket, producing a confidence score for each candidate action alongside the selected response. The model's selection is used as the logical flow condition determining the subsequent action or sequence of actions executed by the playbook engine, as described herein. In some embodiments, the AI model is a classification model trained or fine-tuned on a labeled dataset of historical ticket objects and their confirmed resolution outcomes, enabling the model to generalize from prior resolution patterns to new events exhibiting similar characteristics. When the confidence score associated with the selected response falls below a defined threshold, the system treats the ticket as outside the model's resolution scope and escalates it to a human assignee, transmitting the ticket object, the model's candidate action rankings, and the associated confidence scores to the assignee as structured decision-support information. This escalation mechanism ensures that the autonomous resolution pathway is bounded by a measurable confidence criterion rather than by an unspecified scope determination, and that the human assignee receives structured analytical output from the model rather than an undifferentiated notification. The technical improvement provided by this architecture is the replacement of a structurally unbounded human evaluation step with a computationally bounded inference step for events within the model's resolution scope, while preserving human oversight for events for which the model's confidence does not meet the defined threshold.

In some embodiments, the organization-specific context grounding of the LLM-powered assistant provides a technical capability that is not achievable by a generic large language model lacking access to the organization's operational state. A generic large language model, when presented with an IT or cybersecurity request expressed in natural language, can produce a generically appropriate response based on its training data but cannot resolve requests that are ambiguous without reference to the requesting organization's specific policy configuration, playbook library, asset inventory, and user permissions. For example, a request such as ‘install the application I need for my design work’ is syntactically parseable but semantically underspecified: the set of applications that satisfies the request, the policy governing whether the requesting user is authorized to install software independently or requires administrator approval, and the playbook implementing the installation workflow all depend on organization-specific state that is not available to a generic model. The VICA assistant resolves this class of ambiguity by grounding the LLM's inference in a structured representation of the organization's operational state, retrieved at inference time through retrieval-augmented generation or MCP from the Controller's database or incorporated through fine-tuning on the organization's configuration data. This grounding enables the assistant to map an ambiguous natural language request to a specific, executable playbook in the organization's playbook library, to evaluate whether the requesting user's permissions authorize autonomous execution or require administrator approval per the applicable policy, and to initiate the appropriate workflow with the correct parameters for the requesting user's device and application environment. The technical improvement is therefore an improvement to the accuracy and specificity of natural language request resolution as a function of the context-grounding architecture: the system resolves a class of requests that a generic model returns as ambiguous or incorrect, because the system has programmatic access to the organization-specific state required to disambiguate them. In some embodiments, the grounding data is updated continuously as the Controller's database is updated by agent telemetry and administrative actions, ensuring that the assistant's responses reflect the current operational state of the managed environment rather than a static snapshot.

It will be apparent to those of ordinary skill in the art that the system, method, and process described herein can be implemented as described with regard to FIG. 3, for example as software stored in main memory 850 or read only memory 820 and executed by processor 810. This control logic or software may also be resident on an article of manufacture comprising a computer readable medium having computer readable program code embodied therein and being readable by the mass storage device 825 and for causing the processor 810 to operate in accordance with the methods and teachings herein.

The present invention may also be embodied in a handheld or portable device containing a subset of the computer hardware components described above. For example, the handheld device may be configured to contain only the bus 865, the processor 860, and memory 850 and/or 825. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 860, a data storage device 825, a bus 865, and memory 850, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

It will be appreciated by those of ordinary skill in the art that any configuration of the system may be used for various purposes according to the particular implementation. The control logic or software implementing the present invention can be stored on any machine-readable medium locally or remotely accessible to processor 860. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, etc.

In the description, numerous details are set forth. It will be apparent, however, to one of ordinary skills in the art having the benefit of this disclosure, that the present invention may be practiced without these specific details. In some instances, well-known structures and devices are shown in block diagram form, rather than in detail, in order to avoid obscuring the present invention.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “providing”, “generating”, “propagating”, “distributing”, “transmitting”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Whereas many alterations and modifications of the present invention will no doubt become apparent to a person of ordinary skill in the art after having read the foregoing description, it is to be understood that any particular embodiment shown and described by way of illustration is in no way intended to be considered limiting.

Therefore, references to details of various embodiments are not intended to limit the scope of the claims which in themselves recite only those features regarded as essential to the invention.

What is claimed is:

1. A computer-implemented IT and cybersecurity management system comprising:
a central controller executing on one or more processors and comprising:
a plurality of endpoint agents each deployed on a respective managed endpoint device, each agent communicating with the controller over a secured network connection and configured to manage local resources, enforce security and IT policies, collect telemetry, and execute playbook actions on the managed endpoint device;
a plurality of connectors, each connector configured to interface with one or more managed systems through one or more application programming interfaces (APIs), the managed systems comprising at least one of physical infrastructure, virtualized infrastructure, cloud-hosted services, SaaS applications, network appliances, or security platforms, configured to retrieve telemetry, monitor configuration and security state, and execute control actions on the managed systems in response to instructions generated by the playbook engine;
a browser component executing within the browser process on managed endpoint devices, the browser component controlled by the endpoint agent and comprising a browser-level playbook engine providing visibility into and control over in-browser events;
a playbook engine configured to execute a playbook comprising a tree-structured sequence of action nodes, wherein execution flow through the tree is determined at each node by one or more logical conditions evaluated against the output of the preceding action node;
a unified event schema defining a normalized representation to which event streams from a plurality of distinct IT and cybersecurity domains are translated upon ingestion, each normalized event record encoding at minimum: event type, originating domain, entity identifier, and timestamp;
a correlation engine configured to analyze the normalized event stream to identify multi-domain event sequences in which event records drawn from one or more distinct IT and cybersecurity domains collectively satisfy a composite incident signature; and
the playbook engine further configured to, upon detection of an incident signature by the correlation engine, automatically initiate execution of a corresponding playbook, thereby enabling adaptive execution of incident-responsive operations comprising at least one of: (i) executing remediation, containment, monitoring, or investigative actions across one or more managed endpoints or domains, or (ii) generating and opening an IT service ticket within the system, the ticket encoding incident context, affected entities, and recommended or automated response actions.

2. The system of claim 1, further comprising a browser or browser component executing within the browser process on a managed endpoint device, the browser component controlled by the endpoint agent and configured to:
monitor events occurring within the browser runtime, including in-browser user activity, URL access, content interactions, and browser extension behavior;
enforce security and IT policies at the browser level, including URL filtering, content security controls, tracker removal, and data loss prevention;
authenticate users and provide single sign-on access to corporate resources from within the browser;
implement secure tunneling for access to corporate resources in place of a traditional VPN; and
execute playbook actions within the browser execution context;
wherein the browser component executes a browser-level playbook engine providing visibility into and control over in-browser events that are not accessible to an agent operating at the operating system level of the managed endpoint device.

3. The system of claim 1, wherein each playbook comprises:
a trigger condition defining the event or condition that initiates execution of the playbook;
a tree-structured sequence of one or more action nodes, each action node comprising at least one of: execution of a script or executable file, creation of an IT ticket or notification, web automation simulating user input, invocation of a machine learning model, executing an API call, or a workflow control operation; and
logical flow conditions at each action node that evaluate the output of the preceding action to determine which subsequent action node in the tree is executed next;
wherein the controller or endpoint agent execute the playbook by traversing the tree of action nodes according to the evaluated logical flow conditions until a terminal condition is reached.

4. The system of claim 3, wherein trigger conditions are one or more of:
scheduled triggers executing at defined times or intervals; event-based triggers responsive to detected IT or cybersecurity events, including login or privilege escalation attempts; malware or suspicious code detection; changes to system configuration, access or modification of files, applications or services; anomalous user, network, or application activity; disk, network, or CPU utilization alerts; detection of out-of-date, vulnerable, or unauthorized software components; provisioning or de-provisioning events associated with users, devices, or applications; network connection events including connections to suspicious domains, IP addresses, or services; security alerts generated by endpoint, network, cloud, or SaaS security systems; changes to access permissions, authentication settings, or identity attributes; data transfer or exfiltration events; updates to external threat intelligence, vulnerability, or IT advisory feeds;
compliance or policy violation events; and triggers initiated directly by a system administrator, end user, automated workflow, or external system.

5. The system of claim 1, wherein the playbook engine is configured to autonomously monitor events across the managed IT domains and, upon detection of an event satisfying a trigger condition, to execute an event-to-response pipeline comprising:
translating the detected event into a normalized event record in the unified event schema;
evaluating the normalized event record against one or more logical conditions to produce a severity classification;
generating an IT ticket comprising the normalized event record, the severity classification, and one or more candidate response actions derived from the playbook associated with the trigger condition; and
assigning and delivering the IT ticket to one or more designated system users via one or more of: email, text message, mobile push notification, or messaging platform notification;
wherein the event-to-response pipeline executes within the detection latency of the monitoring system and without any human triage step intervening between event detection and ticket delivery, such that the time from detection of an event satisfying the trigger condition to delivery of the structured IT ticket does not exceed the detection cycle of the monitoring system.

6. The system of claim 5, wherein a response by an assignee to an IT ticket constitutes a logical flow condition in the playbook, and wherein the content of the assignee's response determines the subsequent action or sequence of actions executed by the playbook engine.

7. The system of claim 5, wherein an AI model is configured to autonomously evaluate an IT ticket and select a response, the selected response serving as a logical flow condition determining the subsequent action or sequence of actions executed by the playbook engine, and wherein the AI model is further configured to escalate the ticket to a human assignee when the AI model determines that the ticket falls outside the scope of autonomous resolution.

8. The system of claim 3, wherein a playbook action comprises execution of a machine learning inference step, the output of which is evaluated as a logical flow condition governing subsequent execution of the playbook, the machine learning inference step being performed by at least one of:
an anomaly detection model operating on a sequence of historical and current events to identify deviations from established behavioral baselines;
a supervised classification model producing a classification output used to select among alternative subsequent action nodes; or
a large language model parsing log data, event records, or user-generated text to produce a structured output used as input to the logical flow condition;
wherein the machine learning inference step may execute on the controller, on the endpoint agent, or as a call to an external inference service.

9. The system of claim 1, further comprising an AI-powered assistant interface configured to:
receive natural language input from a system user via a text, voice, or video interface;
process the input using a large language model that incorporates organization-specific context, comprising at least the organization's telemetry information, user's device configuration, applicable enterprise policies, and the available playbook library, through one or more of MCP, in-context prompting, retrieval-augmented generation, or fine-tuning;
and in response to the processed input, return a textual or voice response, trigger an appropriate playbook, or initiate an agentic workflow on the user's behalf, subject to authorization controls enforced by the controller;
wherein the assistant interface enables end users to initiate IT and cybersecurity workflows through conversational interaction without requiring direct administrative access to the system.

10. The system of claim 9, wherein, for a user request that requires administrative authorization before the requested action may be executed, the assistant interface triggers a playbook that creates an IT ticket directed to an administrator for approval, and wherein approval or denial by the administrator is communicated to the user through the assistant interface.

11. The system of claim 1, wherein the controller maintains a compliance control mapping comprising:
a set of control objects, each control object encoding a compliance control drawn from a recognized regulatory or security framework, an association between control objects and one or more playbooks in the system's playbook library whose execution produces the operational outcomes specified in the control object;
an association between control objects and system IT tickets configured to track operational management actions, remediation activities, and evidence artifacts demonstrating compliance with the corresponding control object;
a set of measurable operational outcomes the satisfaction of which fulfills the control, and a set of evidence types that constitute proof of compliance; and
wherein the system supports automated operational compliance with one or more of the following frameworks: SOC 2, ISO 27001, HIPAA, CMMC, PCI DSS, and GDPR.

12. The system of claim 11, wherein the controller is configured to:
continuously monitor, for each control object, whether the associated playbooks are assigned to applicable entities, executing without error, and producing evidence artifacts of the types specified by the control object;
maintain a compliance posture score for each control object, updated in connection with a relevant playbook execution event or telemetry information; and
generate a compliance incident event and trigger a remediation playbook when a control object's posture score falls below a defined threshold;
wherein compliance posture is monitored continuously as a function of normal operational execution rather than through periodic manual audit.

13. The system of claim 11, wherein the controller generates audit-ready compliance evidence packages by aggregating execution records, configuration state records, and evidence artifacts produced as a byproduct of normal playbook execution and collected telemetry data, the evidence packages being formatted to the evidentiary requirements of a specified compliance framework without requiring manual retrospective data collection.

14. The system of claim 11, wherein the controller employs an AI model to perform compliance gap detection comprising:
receiving a prompt corresponding to a compliance control or evidence request;
accessing a contextual organizational database storing information describing the organization's infrastructure, configurations, operational activities, assets, users, policies, prior events, and historical telemetry;
retrieving one or more control definitions associated with the compliance framework, each control definition specifying one or more required evidence types;
evaluating the contextual organizational database together with the retrieved control definitions to determine whether sufficient operational data exists to satisfy the required evidence types;
generating one or more evidence artifacts derived from the contextual organizational data, the artifacts corresponding to the required evidence types of the evaluated control definitions; and
producing a structured compliance response comprising the generated evidence artifacts and metadata linking the artifacts to the corresponding control definitions;
wherein the generated evidence artifacts are stored and made available for compliance reporting, audit preparation, or automated verification of compliance controls.

15. The system of claim 1, wherein the controller is configured to recommend or select playbooks for assignment to entities based on one or more of: the organization's industry, size, and geographic distribution; compliance requirements applicable to the organization; the devices, operating systems, and applications in use; and telemetry data collected from endpoint agents and system components.

16. The system of claim 15, wherein the controller employs an AI model to generate new playbooks tailored to the organization's operational context, and wherein each AI-generated playbook script is subject to a multi-stage verification process before execution that evaluates the script for logical consistency with its action specification and for the absence of operations associated with unauthorized or malicious behavior.

17. The system of claim 1, wherein the controller is configured to propagate a new or updated playbook to managed endpoints through a phased rollout process comprising sequential deployment to increasing proportions of the managed entity population, with automated monitoring of execution outcomes during each deployment phase and automated rollback triggered by execution error rates exceeding a defined threshold during any phase.

18. The system of claim 1, wherein the controller supports management of a plurality of distinct organizational tenants through logical isolation of each tenant's playbook libraries, event logs, user and device data, and compliance records, while enabling cross-tenant learning in which anonymized, aggregated telemetry data from multiple tenants informs playbook recommendations without exposing any tenant's identifiable data to other tenants.
